(19) United States
(12) Patent Application Publication
(10) Pub. No.: US 2011/0094443 A1
(43) Pub. Date: Apr. 28, 2011

(54) MASKING APPARATUS FOR HOUSEHOLD PAINT JOB

(76) Inventor: Steve Karaga, Lawrenceville, GA (US)

(21) Appl. No.: 12/604,203

(22) Filed: Oct. 22, 2009

(51) Int. Cl. B05C 21/00

(52) U.S. Cl. 118/504

(57) ABSTRACT

A representative masking stack having a length and width includes a plurality of masking apparatuses. Each masking apparatus is stacked on top of each other such that the stacked plurality of masking apparatuses have an angled side to easily grasp the edge and remove each masking apparatus from the stack. Each masking apparatus includes polymer coatings on top and bottom sides of the masking apparatus. The masking stack further includes adhesive being applied on the bottom side of each masking apparatus, the adhesive being an acrylic or water based emulsification adhesive formula.

### TECHNICAL FIELD

The present invention relates to a masking apparatus for household paint job, and more particularly, a masking apparatus that incorporates a semi-rigid paper substrate material that enables a user to easily align the masking apparatus along an edge of a household painting surface.

### BACKGROUND

The most tedious part of any household paint job is masking properly to create straight lines between surfaces to be painted and adjacent surfaces to be protected. Typically, masking tapes currently available in the market are manufactured on a thin flimsy substrate having characteristics of a thin paper. Because of the thin paper characteristics, the masking tape folds and rolls onto itself and at times is very difficult for the user to mask the edges and corners of the painting area. It is very slow going and frustrating to peel the tape off of a roll and create straight lines delineating the surface to be protected from the surface to be painted. The results can be defective in terms of being able to create straight crisp lines.

Thus, a heretofore unaddressed need exists in the industry to address the aforementioned deficiencies and inadequacies.

### SUMMARY

A representative masking stack having a length and width includes a plurality of masking apparatuses. Each masking apparatus is stacked on top of each other such that the stacked plurality of masking apparatuses have an angled side to easily grasp the edge and remove each masking apparatus from the stack. Each masking apparatus includes polymer coatings on top and bottom sides of the masking apparatus. The masking stack further includes adhesive being applied on the bottom side of each masking apparatus, the adhesive being an acrylic or water based emulsification adhesive formula.

Other apparatus, methods, features, and advantages of the present invention will be or become apparent to one with skill in the art upon examination of the following drawings and detailed description. It is intended that all such additional apparatus, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view that illustrates an embodiment of a masking stack.

FIG. 2 is a cross-sectional view of an embodiment that illustrates a masking apparatus, such as that shown in FIG. 1.

FIG. 3 is a perspective view of an embodiment that illustrates a masking apparatus, such as that shown in FIG. 2.

FIG. 4 is a perspective view of yet another embodiment of a masking apparatus that includes cutout decorative symbols.

FIG. 5 is a view of an embodiment of a masking apparatus that is rolled up into a circular shape.

### DETAILED DESCRIPTION

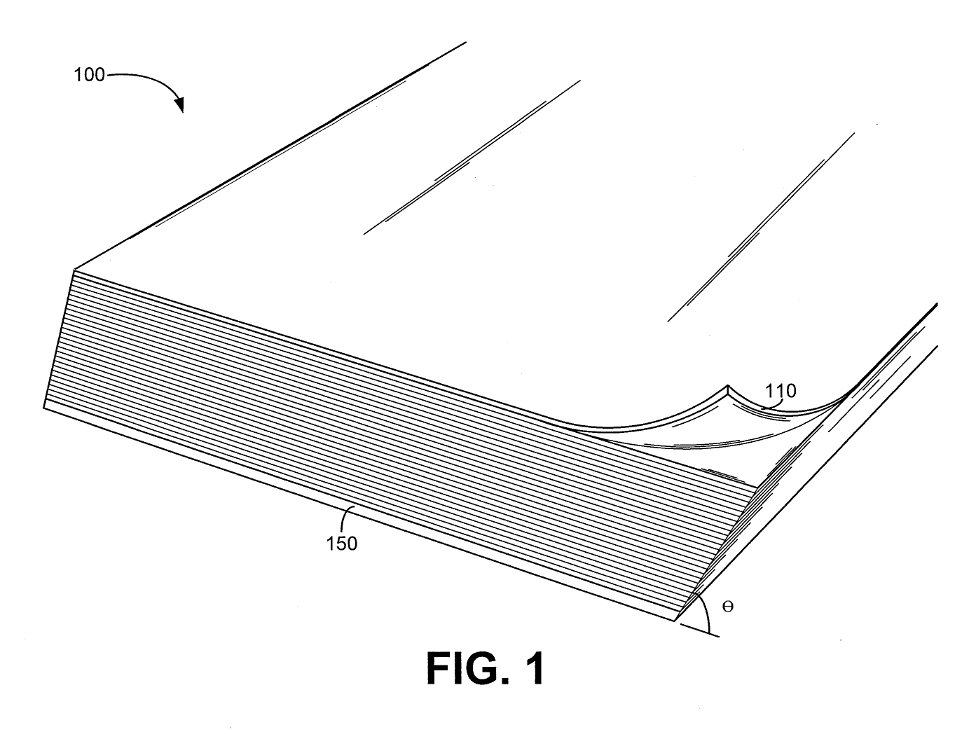

Disclosed are apparatuses and methods for a masking apparatus that facilitates painting a household. Referring now in more detail to the figures in which like reference numerals identify corresponding parts, FIG. 1 is a perspective view that illustrates an embodiment of a masking stack 100. Each masking apparatus 110 is manufactured in 36″ lengths that allow for optimum ease of handling, having a width from approximately ¾ inch to two (2) inches. Each masking apparatus 110 of the masking stack 100 is manufactured in easy to handle lengths utilizing a semi-rigid paper substrate coated on top and bottom surfaces with a polymer coating. The masking apparatuses are placed on top of each other, forming the masking stack 100.

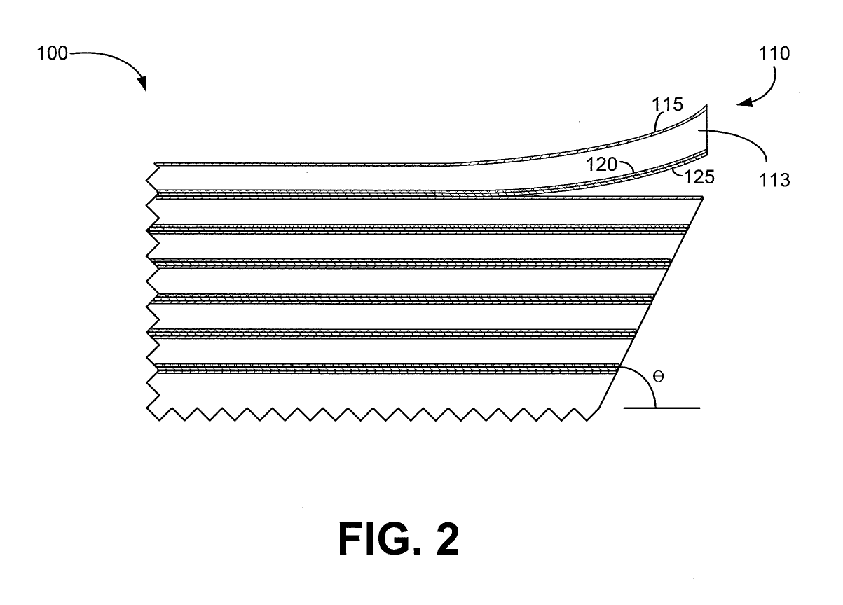

The removal of each masking apparatus 110 is further facilitated by cutting at least one side of the masking stack 100 at an angle θ (e.g., approximately 67.5 degrees). This allows the user to easily grasp the edge and remove each masking apparatus 110 from the masking stack 100. The masking stack 100 includes a rigid bottom base 150 that serves to maintain a substantially straight structure of the masking stack 100 from the removal of the very first masking apparatus 110 through the consumption of the final masking apparatus 100 in the masking stack 100. This base 150 maintains the overall stiffness of the whole stack 100 which greatly enhances ease of use. The base 150 can be made of, but is not limited to, styrene plastic with a thickness of approximately 0.030 inches. The base 150 can be corona treated on a surface opposite of the masking apparatus 110 so that printing can be placed on the corona treated side of the base 150. The masking stack 100 is further described in relation to FIG. 2.

FIG. 2 is a cross-sectional view of an embodiment that illustrates a masking apparatus, such as that shown in FIG. 1. Each masking apparatus 110 includes a semi-rigid substrate 113 having rigidity to maintain a substantially straight line without external force and flexibility to flow with irregularities or curves on an edge of a painting surface to be protected. The semi-rigid substrate 113 includes a paper base having specific characteristics that maintain adequate rigidity to achieve a consistently straight line at the leading edge to facilitate ease of use and maintenance of line integrity while allowing just enough flexibility to flow over minor surface imperfections and maintaining a protective seal to prevent seepage onto the protected adjacent edges. The semi-rigid substrate 113 can include, but is not limited to, polyethylene, propylene, paper base, paper card stock, sheet plastic extrusion, and resins. Also, the semi-rigid substrate 113 includes a basis weight of 120 pounds per ream.

Each masking apparatus 110 further includes a release side incorporating the release agent added to the polymer coating 115 and an adhesive side 120 allowing them to be conveniently packaged and easily removed for using one masking apparatus 110 at a time. Specifically, each masking apparatus 110 includes polymer coatings 115, 120 on respective top and bottom sides of the masking apparatus 110. The top side is coated with a release agent polymer 115 and the bottom side is coated with a matt finish polymer 120 designed to retain adhesive 125. The release agent polymer 115 facilitates easy removal of a single masking apparatus 110 from the masking stack 100 without resulting in curling of the masking apparatus 110. The polymer coatings 115, 120 provide additional protection by preventing any paint from penetrating through the masking apparatus 110.

The matt finish polymer 120 can include, for example, an acrylic coated paper (e.g., NT 186B). The release agent polymer 115 can be coated with a tint or dye to achieve a blue color. The adhesive side 120 can be white which is a removable pressure sensitized self wound boardy paper tape. This paper tape is a moisture resistant polyethylene coated paper having silicone release coating that facilitates unwind and separation of each masking apparatus 110. The adhesive 125 includes an acrylic or water based emulsification adhesive formula that allows the masking apparatus 110 to be removed easily so as not to cause curling to the masking apparatus 110 when the masking apparatus 110 is peeled from the stack 100. The adhesive 125 is designed to remove easily from the top polymer coating 115 of the adjacent masking apparatus while temporarily adhering to the surface to be protected and incorporating an adhesive with substantial and sufficient thickness to create a seal such that the paint does not seep beyond the edge of the masking apparatus 110.

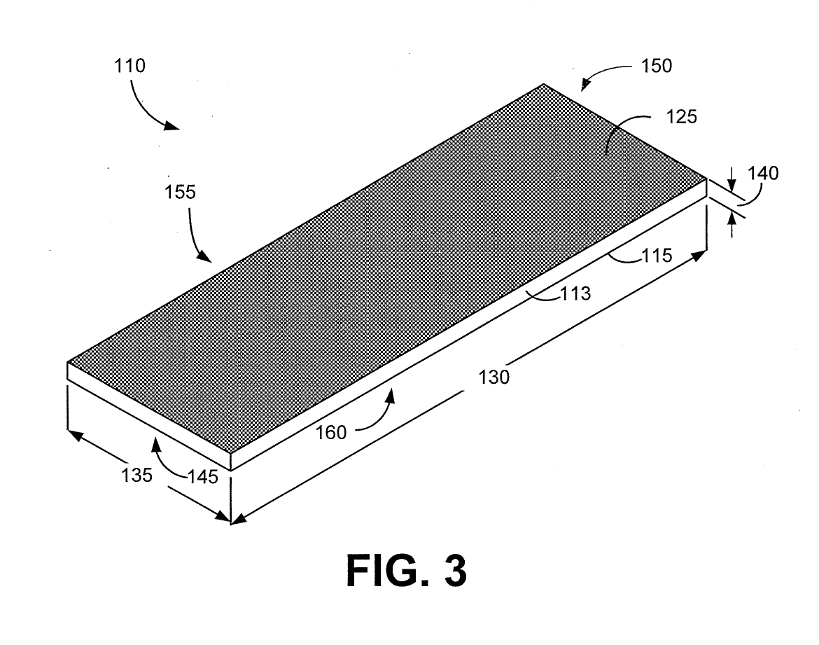

FIG. 3 is a perspective view of an embodiment that illustrates a masking apparatus, such as that shown in FIG. 2. The thicknesses of the semi-rigid substrate 113, each polymer coating 115, 120, and the adhesive are 6.8 millimeters (mm), 1.0 mm, and 1.8 mm, respectively, making the total thickness 140 of the masking apparatus 110 at approximately 10.6 mm. The performance of the masking apparatus 110 using the adhesive thickness at 1.8 mm to 4.0 mm with 95%-100% removable acrylic adhesive and 5%-0% permanent acrylic adhesive is optimized based on the static energy of the substrate combined with the polymer coatings when incorporating a substrate with adequate rigidity to maintain straightness for various applications. The masking apparatus 110 achieves the following: 1) bonds firmly on a painting surface, 2) does not pull off paint from the painting surface when removed, and 3) does not allow paint to seep along the edges, among others.

Each masking apparatus 110 has a rectangular shape having ends 145, 150 that are substantially perpendicular to the sides 155, 160 of the masking apparatus 110. The perpendicular edges 145, 150 can be useful during the course of household painting, allowing the user to start or finish at corners that are substantially perpendicular. The semi-rigid substrate 113 can include a cross grain structure which allows the users to easily tear the masking apparatus at a 90 degree angle. These types of tear-offs are common in corner protection type applications.

The length 130 and width 135 of the masking apparatus 110 are designed in a various dimensions, including lengths of approximately 36 inches to 8 to 9 feet and widths of approximately ¾ inch to 6 inches (or even wider) depending on the user's preference. Preferably, the masking apparatus 110 having ¾ inch to 3 inches in width and 36 inches in length is used for paint surface corners and edges.

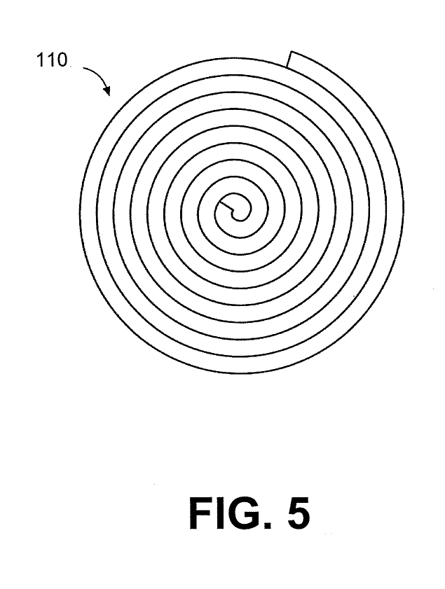

Alternatively or additionally, the masking apparatus 110 having widths and lengths greater than 2 inches and 36 inches can be used to facilitate painting stripes on walls. The wall striping masking apparatus 110 can be made in rolls, such as that shown in FIG. 5, while being cut into lengths of approximately 8 to 10 feet. FIG. 5 is a view of an embodiment of a rolled masking apparatus 110 that is rolled up into a circular shape. Any of the masking apparatus 110 described above could be curled at one end to be rolled up. A tape could be applied to the outer end of the masking apparatus 110 or a rubber band could be placed around the rolled masking apparatus 110 to maintain the rolled position. An advantage, among others, is that the rolled masking apparatus 110 could save storage space. The wall striping masking apparatus is easily removed from the roll since it is cut or perforated at predetermined lengths of 8 to 10 feet. The usefulness of the pre-cut or perforation is to allow users to remove a single apparatus that will span the full height of the wall. The wall striping masking apparatus can be packaged to include set-reusable spacers to easily align the wall striping masking apparatus 110 in substantially parallel and equidistant lines. By painting between the wall striping masking apparatus 110; wall striping is easily achieved without the effort of measuring, pencil marking and attempting to create straight parallel line results with the use of traditional masking tape.

Preferably, a wall is masked with parallel and equidistant masking apparatus' after which the entire surface can be painted easily with a roller; while the apparatus protects the surfaces lying beneath each apparatus. After the paint has dried, the masking apparatuses can be removed. If a different color is desired over the masked area, the striping masking apparatuses are placed over the dried paint and a second coat of paint can be applied to create a two tone finish. Alternatively, if desired, the user could paint any number of colors between each masking apparatus to create a wall of multiple color stripes.

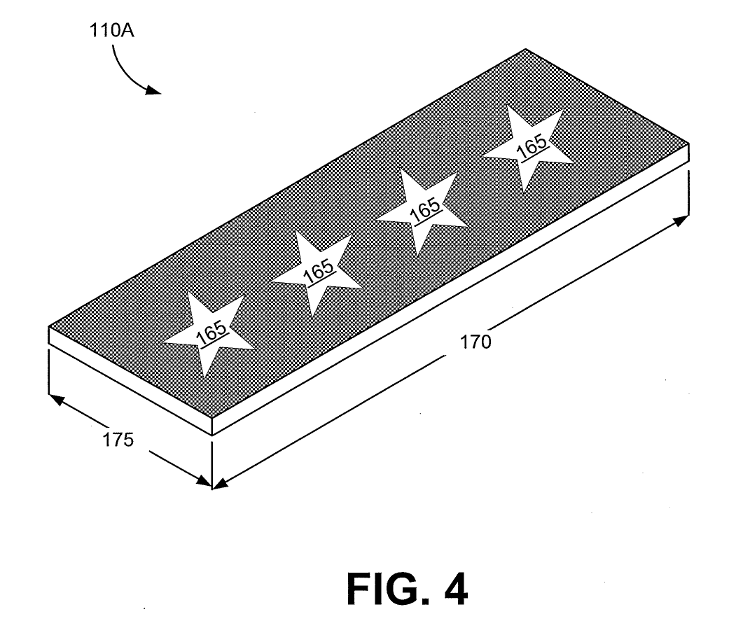

FIG. 4 is a perspective view of yet another embodiment of a masking apparatus that includes cutout decorative symbols. The masking stack 100 can be cut (e.g., by way of laser) to include a wide variety of decorative symbols. In this example, the decorative symbol is a star 165. The masking stack 100 can be manufactured in dimension of approximately 12 inches in width 175 by 60 inches in length 170. Since each masking apparatus 110A are adhesive coated and made with a release polymer on the top, each masking apparatus 110A can easily be removed from the stack and conveniently be placed for stenciling work. Stencils currently available do not offer such structural configuration. The stenciled masking apparatus with adhesive coating protects the adjacent surfaces outside of the laser cut lines to be painted. Drips and seepage are virtually eliminated. The masking apparatus 110A can further have wavy sides (not shown) along with length of the masking apparatus 110A. The cut lines of the decorative symbols could be tapered or perpendicular to the top surface of the masking apparatus 110A. The masking apparatus 110A further has an adhesive layer 125 having adhesive that covers substantially the entire top surface. A baby room, for example, can be easily painted with symbols that include, but are not limited to, alphabetical letters, numbers, stars, moons, suns, and dinosaurs, etc.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A masking stack having a length and width, comprising:
a plurality of masking apparatuses, each masking apparatus being stacked on top of each other such that the stacked plurality of masking apparatuses have an angled side to easily grasp the edge and remove each masking apparatus from the stack, each masking apparatus including polymer coatings on top and bottom sides of the masking apparatus; and
adhesive being applied on the bottom side of each masking apparatus, the adhesive being an acrylic or water based emulsification adhesive formula.

2. The masking stack of claim 1, wherein each masking apparatus includes a semi-rigid substrate that is made of at least one of the following: polyethylene, propylene, paper base, paper card stock, sheet plastic extrusion, and resins.

3. The masking stack of claim 2, wherein the semi-rigid substrate of the masking apparatus has a rigidity to maintain a substantially straight line without external force and flexibility to flow with irregularities or curves on an edge of a painting surface to be protected, the width of the rigid backing layer being approximately three (3) inches and the length being approximately three (3) feet.

4. The masking stack of claim 3, wherein each masking apparatus is made of semi-rigid substrate having a basis weight of approximately 120 pounds per ream.

5. The masking stack of claim 3, wherein the semi-rigid substrate has a cross grain structure which allows the users to easily tear the masking apparatus at a 90 degree angle.

6. The masking stack of claim 2, wherein the semi-rigid substrate has a rigidity to maintain a substantially straight line without external force and flexibility to flow with irregularities or curves on an edge of a painting surface to be protected, the width of the rigid backing layer being approximately one (1) foot and the length being approximately three (3) feet such that multiple tone decorative painting can be accomplished.

7. The masking stack of claim 6, wherein a portion of the semi-rigid substrate has a cutout decorative symbol that is formed by a cut line.
